(19) United States
(12) Patent Application Publication
(10) Pub. No.: US 2012/0053706 A1
(43) Pub. Date: Mar. 1, 2012

(54) DEVICE FOR CONTROLLING AND PROFILING FIELD CONDITIONS AND METHOD THEREFOR

(75) Inventors: A.S.M Mukter-Uz-Zaman, Kuala Lumpur (MY); Wahab Bin Abdullah Abdul, Kuala Lumpur (MY); Othman Masuri, Kuala Lumpur (MY); Hasmi Bin Wan Kamal Wan, Kuala Lumpur (MY)

(73) Assignee: Mimos Berhad, Kuala Lumpur (MY)

(21) Appl. No.: 13/145,140

(22) PCT Filed: Jan. 19, 2010
(86) PCT No.: PCT/MY2010/000013

§ 371 Date: Nov. 3, 2011

(30) Foreign Application Priority Data
Jan. 22, 2009 (MY) PI 20090299

(51) Int. Cl. G06F 17/00

(52) U.S. Cl. 700/90

(57) ABSTRACT

The present invention relates to a device (500) configured to profile and control field conditions for plants grown in an environment. The device (500) is essentially comprised of at least one integrated sensor systems (10) configured to acquire data associated with the field conditions, and at least one feedback control system (20) for regulating the field conditions. The device (500) further comprises an inference unit configured for receiving and profiling the data from the integrated sensor systems (10); determining revised field conditions in accordance to the plants' requirements based on the data acquired from said integrated sensor system (10), and manipulating the feedback control system (20) in a feedback manner to regulate the field conditions in the environment into the revised state. In addition, the inference unit is in communication with the monitoring component and the controlling component via connections.

### FIELD OF THE INVENTION

The present invention relates to a device for controlling and profiling field conditions and method therefor.

### BACKGROUND ART

It has been known in the related art that all types of crops and vegetables can be planted in any places, provided that they are planted in an appropriate environment. The temperature, the humidity, and the type of the soil are generally considered when selecting an area for plantation that has the appropriate environment.

As a result of these requirements for an appropriate environment to produce high-quality crops and for productive vegetation, farmers and plantation owners alike, in unison, have admitted that the task of searching for an arable land is indeed an arduous effort. It has been a usual practice to conduct some examinations on the soil and the weather throughout an entire year to determine the eligibility of the land. Moreover, said task could be more arduous since the eligibility of the land also largely depends on the type of plants to be cultivated. Thus, therefore arises a need to control the environment if possible and this has led to the birth of greenhouses in which crops and vegetables can be controlled in an enclosed area. The provision of an environment would inconspicuously benefit in that different kinds high value and premium of crop and vegetable can be planted that in turn would yield significant economic benefit to the farmers and country generally.

In addition, there would also be less arable land due to rapid industrialization. Further more with the increasing population, the demand for food and agriculture product would surge prompting the demand in aggressive shift in the agriculture practices. As such, the scarcity of arable land and the demand for food cause green houses are sprouted in various sizes, small and medium for agriculture, complementing the food production contributed by relatively larger plantations that is unstoppably diminishing. Although the greenhouses have appeared to address the problems attributed to diminishing arable land and the surging food demand, they have yet to overcome problems associated with controlling the environment in the greenhouses in order to obtain the maximum yield.

In the art of growing plants within an environment like a greenhouse, it has been well known that the plants' growth is highly dependent on factors such as light, temperature, atmospheric gases and humidity. To control the temperature within a greenhouse, it is the subject of the document, i.e. U.S. Pat. No. 5,009,029 that describes a conductive temperature control system for plant cultivation. The present invention relates to a method and apparatus using heat conduction to control the temperature to grow plants of various kinds. It is described in the document that the system has an application for improving the growth of all horticulture products affected by temperature variations. Although the system can manage the temperature, there remain other factors that can limit the growth of the plants in the environment.

In order to provide the solution to control some other parameters that can affect the plants' growth, it is also a subject of the document, i.e. EP 1,374,667 A2, which describes a small-sized greenhouse with an internal environment. It is described therein that separate sensors are utilized to measure the condition of different parameter in the greenhouse and the result of measurement would be displayed on a display unit. Then, a user may refer to the displayed data and perform some initiatives to alter the parameter that is required to be adjusted. However, it is considered as inconvenient to use separate sensors and human intervention to monitor and control the internal condition, and as such, there still appears a need for an integrated system that can monitor and control the parameters with no human intervention at all.

Aside from that, human intervention would also inevitably result to a delayed action to control the parameters. If it is such a case of a large plantation, more workers with the expertise may be required on site for performing the said control activity. The size of the plantation in an environment must also be limited due to ease the task of monitoring and controlling the parameters simultaneously.

Therefore, a device and a method that can eliminate the above mentioned limitations should be provided.

### SUMMARY OF THE INVENTION

Accordingly, to solve the disadvantages and drawbacks of the prior art, there are provided a device configured to profile and control a plurality of field conditions associated with plants grown in an environment, and a method therefor.

In one aspect of the present invention, the device is essentially configured for profiling and controlling the field conditions is essentially comprised of at least one integrated sensor systems configured to acquire data associated with the field conditions, and at least one feedback control system configured for regulating the field conditions. The device of the present invention is further comprised of an inference unit configured for receiving and profiling the data from the integrated sensor systems, determining revised field conditions in accordance to the plants' requirements based on the data acquired from the integrated sensor system, and manipulating the feedback control system in a feedback manner to regulate the field conditions in the environment into the revised state. The inference unit is adapted to be in communication with the monitoring component and the controlling component via connections thereof.

In another aspect of the present invention, a method for profiling and controlling field conditions associated with plants grown in an environment by means of the afore-mentioned device. The method essentially comprises the steps of sensing and measuring field conditions by means of at least one integrated sensor system, wherein the integrated sensor systems comprises a plurality of sensors therein configured to measure the field conditions in the environment; transmitting data of the measured field conditions to a inference unit; profiling the data of the measured field conditions, determining revised field conditions in accordance to the plants' requirements based on the data, sending feedback commands to at least one feedback control system, by means of a inference unit; and finally regulating the field conditions in the environment into the revised state in accordance to the feedback commands received therefrom, by means of the feedback control system, wherein the feedback control system comprises a plurality of field condition regulators.

It is an object of the present invention to provide an engineering method that is capable of profiling and controlling at least one field condition that includes soil condition, temperature and humidity in the environment.

It is also an object of the present invention to provide the device with a plurality of integrated sensor system wherein more than one field condition can be monitored from a sensing unit. Also, the environment needed by the plants can be assessed, determined, and revised.

It is a further object of the present invention to provide a precise control of the soil and environment condition that is conducted via a closed-feedback system through the incorporation of some valves system. More than one field condition can be controlled from the feedback control system resulting a more conducive environment can therefore be generated.

It is a further object of the present invention to provide a device that is capable of monitoring the entire environment without any human intervention. The whole process to profile and control the field conditions in the environment are entirely automated without supervision from the user. However, the user can still monitor the current condition of the environment from anywhere in such a manner that brings a new dimension of a flexible monitoring of the environment.

It is a further object of the present invention to provide a device that can execute a real time data analysis. The values acquired using the sensors in the device are utilized to revise and change the environment of the controlled area such that appropriate environment for the plant can therefore be achieved in real-time and the production and health of the plants cultivated can be maintained to have high quality.

It is a further object of the present invention to provide a device that can store information of the change of environment, which can later be used for a big plantation area. The device is adaptable to a small-scale plantation to a big plantation by providing a preferred embodiment of the present invention suitable for the said requirement.

It is a final object of the present invention to provide a plurality of the integrated sensor systems and a plurality of the feedback control systems that are arranged in a plurality of arrays. The arrays each would include a main portal that can optionally send the data to the inference unit in wireless or in a wired manner for the user's mobile monitoring. The integrated sensor systems and the feedback control systems each are incorporated with a daisy chain controller, which can activate or deactivate, and control them in accordance to the commands received from the inference unit.

The present invention consists of certain novel features and a combination of parts hereinafter fully described and illustrated in the accompanying drawings and particularly pointed out in the appended claims; it being understood that various changes in the details may be without departing from the scope of the invention or sacrificing any of the advantages of the present invention.

### BRIEF DESCRIPTION OF THE DRAWINGS

For the purpose of facilitating an understanding of the invention, there is illustrated in the accompanying drawings the preferred embodiments from an inspection of which when considered in connection with the following description, the invention, its construction and operation and many of its advantages would be readily understood and appreciated.

FIG. 1 shows a daisy chain arrangement of the sensors of a preferred embodiment of the present invention in the environment.

FIG. 2 shows a daisy chain arrangement of the sensors of another preferred embodiment of the present invention in the environment.

FIG. 3 shows a magnified view of a wireless gateway and the sensing units arranged in array of the present invention.

FIG. 4 shows a block diagram of an integrated sensor system of which the number of sensors at the tip thereof can be varied.

FIG. 5 shows a block diagram of a feedback control system of the present invention.

FIG. 6 shows a block diagram of a main portal of the present invention.

FIG. 7 shows a block diagram of the steps executed in the method as practiced in the present invention

### DETAILED DESCRIPTION OF THE PREFERRED EMBODIMENTS

The present invention relates to a device 500 for controlling and profiling field conditions for plants in an environment, and method therefor. Hereinafter, the device 500 shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

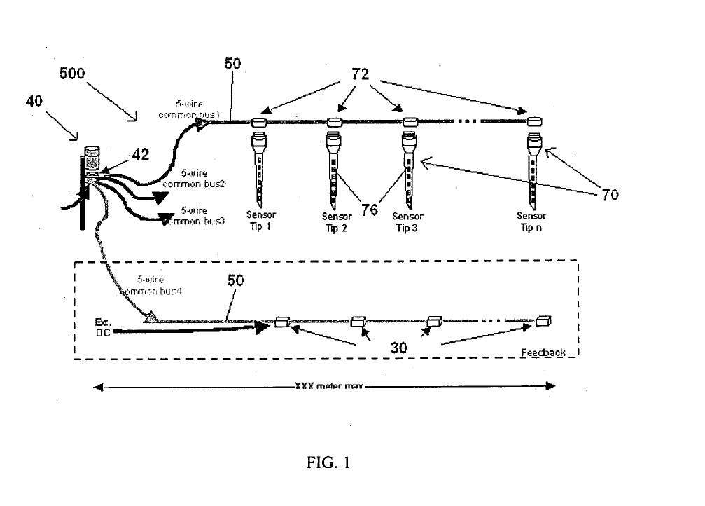

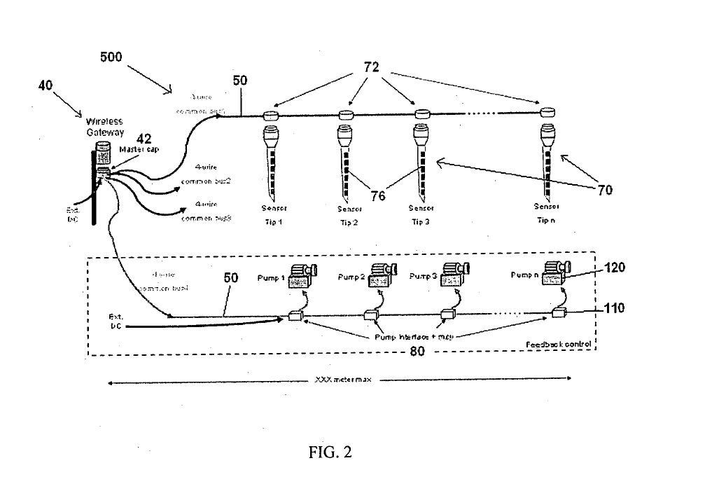

Referring now to different figures of the drawings, the FIGS. 1 and 2 shows the device 500 of the present invention. The device 500 is essentially configured to profile and control the soil, the temperature and the humidity in an environment in order to preferably enable a plantation that produces high-value and high premium crops and vegetables.

Briefly, the device 500 is preferably comprised of at least one integrated sensor system 10. The integrated sensor system 10 is essentially constituted of a sensor 60 or more. The sensor(s) 60 is configured for measuring an affecting parameter/field condition and for acquiring data associated with the measured field condition. If more than one sensor 60 is used, the sensors 60 are preferably limited to one field condition measured per one sensor basis. In addition, it is also preferred that the device 500 further comprises an inference unit (not shown). It is preferred in the present invention that the inference unit is any type of a PC-based system or any other similar system that can perform the same. The field condition(s) in the environment is essentially monitored by means of the inference unit. The inference unit is therefore configured to receive and profile the data from the integrated sensor system 10, and determining revised field conditions in accordance to the plants' requirements based on the data from the integrated sensor systems 10.

Apart from that, the device 500 is also preferred to further comprise at least one feedback control system 20. The feedback control system 20 is essentially configured for regulating the field conditions in the environment. Accordingly, the inference unit, besides functioned to read the field conditions in the environment, also essentially activates the feedback control system 20 and regulates the field conditions in the said environment by means of the inference unit. In addition, it is also preferred that the feedback control system 20 is comprised of a field condition regulator 30. Aside from that, the inference unit is essentially adapted to be in communication with the integrated sensor system 10 and the feedback control system 20, preferably via some wired connection or wireless protocol, depending on the most preferred embodiment of the present invention.

Also preferably provided in the device 500 is a main portal 40. The main portal 40 is configured for receiving data of the measured field conditions from the integrated sensor system 10, sending and receiving data in signals to and from the inference unit by means of a wireless protocol, and sending commands obtained from the inference unit to the feedback control system (20) and the integrated sensor system (10) for control and profiling thereof. The main portal 40 is connected to the integrated sensor system 10 and the feedback control system 20 by means of multiple wire bus 50, as will be hereinafter described in greater detail.

Referring now to FIG. 1, according to one of the most preferred embodiment of the present invention, the device 500 of the present invention is most preferably comprised of integrated sensor systems 10 and feedback control systems 20, as shown. The device 500 is preferably arranged in an array 90 in any one environment as shown in FIG. 1. Accordingly, greenhouses or any other similar construction, usually an enclosed structure that permits light permeation therethrough, can be adapted as the environment, preferably as of the present invention.

Referring again to FIG. 1, the integrated sensor system 10 is preferably housed in a sensing unit 70, as in the present case, a sensor rod 70. These sensor rods 70 are preferably arranged in a daisy chain arrangement as shown. They 70 are usually placed across a plant bed (not shown) to effectively perform the task of collecting information about the soil condition and moisture of the soil.

Referring now to FIG. 2, the block diagram of a sensor rod is illustrated. The sensors 60, as required to monitor the field conditions of the closed plantation environment or within the range of sensitivity of the sensors 60 in the environment, are preferably mounted at the sensor tip 76 of the sensor rod 70. The number of sensors on the tip 76 are preferably can be varied depending on the preferred embodiment of the present invention, with respect to different sensors 60 which are required to be integrated inside the sensor rod 70. Accordingly, the integrated sensors 60 in the sensor rod 70 are preferably daisy-chained (in a cascaded manner) along the plantation bed depending on the requirement thereof, and as an instance; the daisy chain arrangement is shown in FIGS. 1 and 2. It is also preferred that other positioning of the sensors 60 can also be adopted on the device 500 of the present invention.

Referring now to FIG. 4, the device is capable of dynamic profiling determination by means of the integrated sensors 60 illustrated therein. These integrated sensors 60 are operated by means of interconnecting them through bus lines (not shown). Some of the integrated sensors 60 are each configured to measure the content of phosphate, nitrate, and potassium respectively in the soil. It is also preferred that one of the integrated sensors 60 is configured to measure the pH in the soil. Other sensors 60 configured to measure other affecting parameters/field conditions can also be integrated therewith for more precise profiling of the environment. In addition, some of the integrated sensors 60 apart from the above-described are preferably configured to measure the ambient temperature, humidity/moisture and any other affecting parameters associated with the environment.

Referring again to FIGS. 1 & 2, the sensing unit 70 is consisted of a bus cap 72 and the afore-mentioned sensor tip 76. The bus cap 72 is located above the sensor tip 76. As such, the integrated sensor system 10 is divided into two sections respectively at the sensor tip 76 and the bus cap 72. Essentially, the integrated sensor system 10 is provided with a sensing circuitry (not shown) to generate some sort of voltage therein. With reference again to FIG. 4, it is preferred that these sensors 60 are connected to a ReadOut Integrated Circuit (ROIC) 16 and a Micro Controller Unit (MCU) 15. Similarly to the sensors 60, the ROIC 16 and the MCU 15 are connectedly arranged in the sensor tip 76 as illustrated in FIG. 4. The ROIC 16 is configured to convert the voltage to a digital value whilst the MCU 15 is configured to control the integrated sensor system 10, the ROIC 16 and a serial memory unit of the main portal 40, as will be hereinafter described in greater detail. Also, in an alternative manner, the collected sensor values can also be converted to digital bit stream by means of a low cost ADC converter.

Referring still to FIG. 4, provided in the bus cap 72 is a daisy chain controller 12 that is essentially configured to select the different modes of operation (sleep, idle, or active) and also to assign the particular sensor to access the bus lines, in accordance to the commands sent from the inference unit. Also provided in the bus cap 72 is the transceiver unit 11 connected theresuch to the daisy chain controller 12 as shown in FIG. 4. The transceiver unit 11 is configured to transmit the acquired data of the field conditions to the main portal 40. Accordingly, the integrated sensor system 10 operates on a battery module, which can be preferably rechargeable and autonomous.

Referring now to FIG. 5, there are a few different types of field condition regulator 30 being provided on the feedback control system 20. They 30 include a number of fertilizer-supplying units 80 that are each configured to supply a particular type of fertilizer to the soil of the plants. The type and content of fertilizer are supplied in accordance to the type of the plant, and also based on the content of certain composition (phosphate, nitrate, and potassium) in the soil as measured by the integrated sensor system 10. Also, as illustrated in FIG. 2, it is preferred that the fertilizer supplying units 80 each are adapted as a piping system 80 with a pump 120 to extract the fertilizer from a fertilizer storing unit (not shown) and valves 110 to release fertilizer solution when required.

There are also other types of field condition regulators that can be incorporated into the feedback control system 20 depending on the preferred embodiment of the present invention. They 30 include a water-supplying unit (not shown) that is configured to maintain the water content required by the plants; a temperature-regulating unit (not shown); and a humidity or moisture-regulating unit. The field condition regulators 30 are therefore activated to supply the required parameter/field condition such that the appropriate environment level is maintained throughout a plantation area. In addition, it is also preferred that other appropriate types of field condition regulator 30 can also be employed/incorporated in the present invention to efficiently control the parameters in the environment.

Referring still to FIG. 5, the feedback control system 20 is further comprised of a microcontroller unit (MCU) 25 mounted therein. The MCU 25 is configured to receive feedback signal from the inference unit via the main portal 40 and to assess the measured field conditions based on predefined values. Apart from that, also provided on the feedback control system 20 is a daisy chain controller 22. The daisy chain controller 22 is configured to activate or deactivate the field condition regulator 30. In addition, further provided on the feedback control system 10 is a relay array 26. The relay array 26 is essentially configured to activate and operate the field condition regulator selected based on the feedback signal.

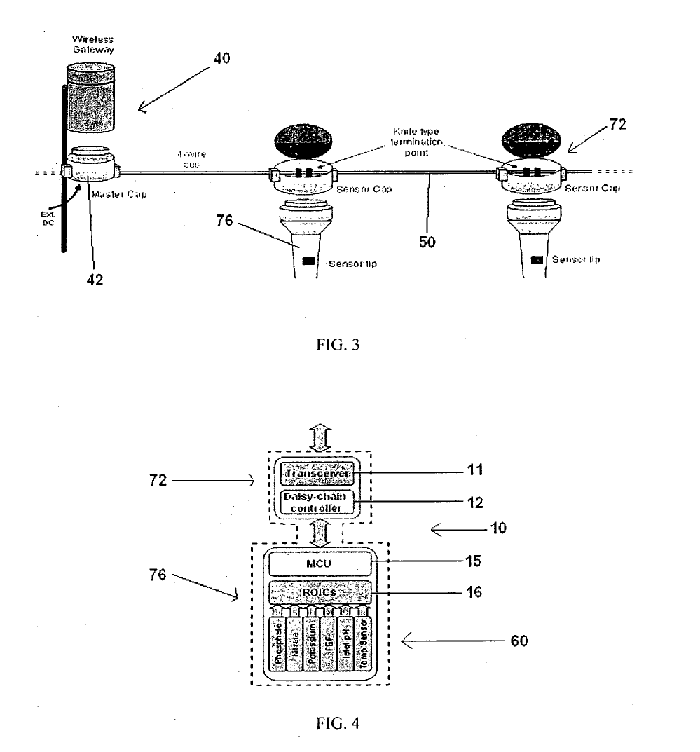

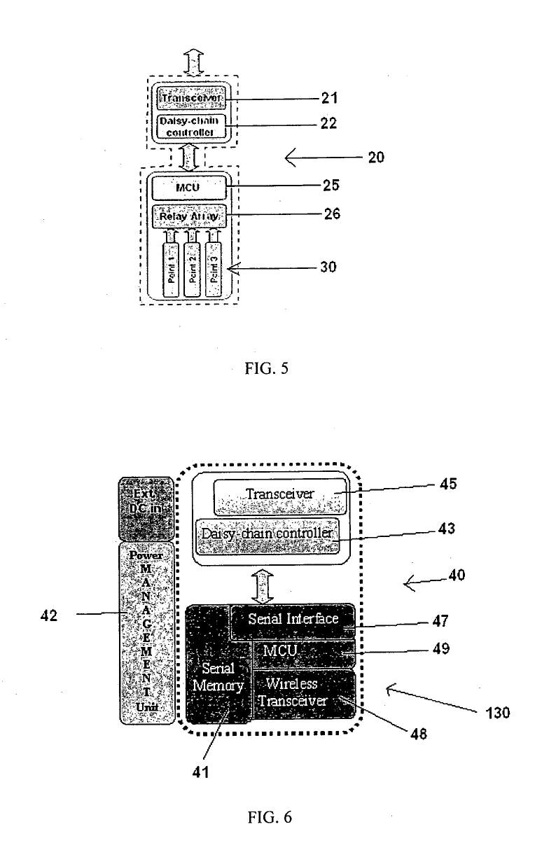

Referring now to FIG. 3, all the sensor rods 70 are illustrated connected with some type of bus 50, preferably using a 5-wire daisy chain bus. All the sensor rods 70 each are also shown comprising a bus cap 72 and the said common bus 50 is connected from the bus caps 72 to a wireless data transmitter/wireless gateway adapted as the main portal 40. The wireless gateway 40 is shown having a master cap 130 in FIG. 3. The master cap 130 is preferably comprised of a Power Management (PM) unit 42, a transceiver 45, a daisy chain controller 43, a serial interface 47, a microcontroller unit (MCU) 49, a wireless transceiver 48, and a serial memory 41. The said daisy chain controller 43 and the transceiver 45 are adapted to be located at the master cap 130.

Accordingly, it is preferred that all the collected data (from the integrated sensor system 10) is transmitted to a personal computer adapted as the inference unit by means of a wireless protocol of any type. Also preferably, in a small greenhouse that is adapted as the environment, the sensor rods 70 are wired and the sensor data are taken based on certain multiplexing technique by a PC-based software. For a large green house environment, wireless data communication can be used to collect the sensor data. Based on the data, a feedback control is activated to open/close the valves 110 so as to maintain the required environment conveniently to the extent of without human intervention. Referring again to FIG. 1, it is most preferred that the integrated sensor systems 10 and the feedback control systems 20 are arranged in arrays 90. Only certain number of the integrated sensor systems 10 and certain number of the feedback control systems 20 are limited to be incorporated into an array 90. Also preferably provided on the array 90 is one wireless gateway 40. The number of the wireless gateway 40 is preferably limited to one unit per an array 90 as shown in FIG. 1. With reference to FIG. 1, other additional rows (not shown) of the integrated sensor system 10 and the feedback control system 20 are allowed to be connected in series to the existing array (90), to the main portal 40. The other rows can be connected by means of other multiple-wire bus (50) as illustrated in the FIG. 1.

Based on the data, the PC-based system adapted, as the inference unit would activate the necessary feedback control such that that the environment in the green house can be controlled according to the plants requirements. The real-time data sent to the said PC would be analyzed and in the feedback control, the PC-based system then activates the control supply in such a manner that appropriate level of fertilizer is maintained throughout the entire area of plantation. The precise control of the soil and environment conditions is preferably conducted via a closed-feedback system through the incorporation of said valves system 110. The valves 110 each would open and close such that the soil fertility and the environment in the green house/environment are within the required control, without any human intervention.

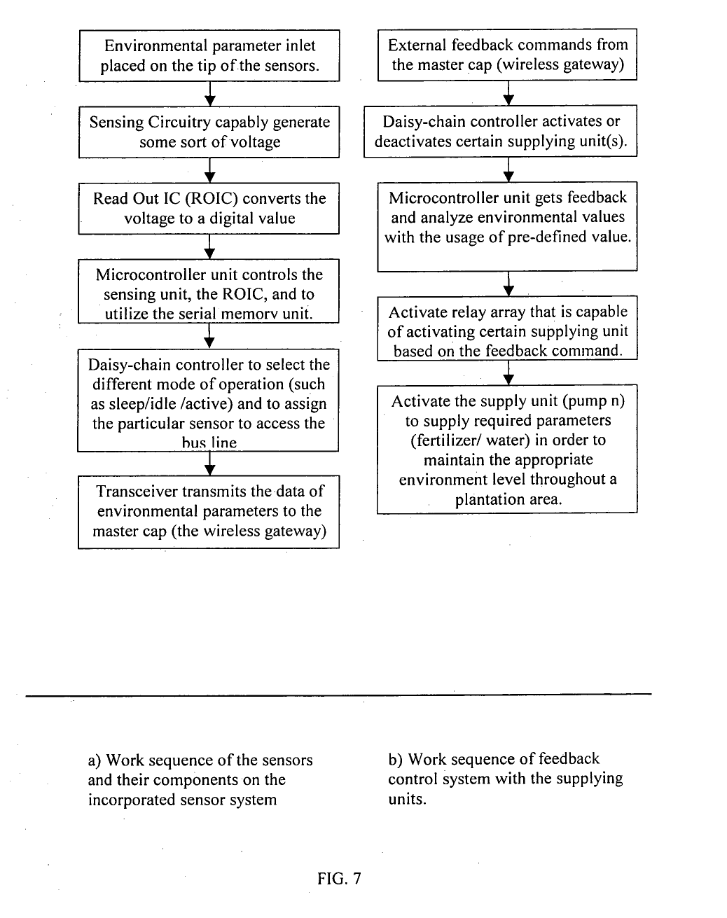

Referring now to FIG. 7, according to another aspect of the present invention, a process to profile and control the parameters/field conditions of the plants grown in the environment/greenhouse is shown. The process is shown commencing with sensing and measuring field conditions by means of integrated sensor systems 10. A voltage is then generated in accordance to the measured field condition by means of the sensing circuitry. The voltage is then converted to a digital value by means of the ROIC 16. The collected data is later transmitted to the PC-based system.

The PC-based system then profiles the data of the measured parameters/field conditions, determines revised field conditions based on the data, according to the plants' requirements, and sends feedback commands to the feedback control system 20. According to the feedback control devised by the PC-based system in commands form, the microcontroller unit 49 controls the integrated sensor system 10, the ROIC 16, and utilizes the serial memory unit 41 of the wireless gateway 40. These actions are then followed by the daisy chain controller 43 selecting the different mode of operation (sleep/idle/active) of the sensors 60 and assigning the particular sensor to access the bus line.

Referring still to FIG. 7, according to the commands sent from the PC-based system, the parameters/field conditions are regulated into the revised state according to the feedback commands. The regulation step is then followed by activating or deactivating the field condition regulators 30 by means of the corresponding daisy-chain controller 22 in accordance to the feedback commands. The microcontroller unit 25 then acquires the feedback and analyzes the environment value with pre-defined value. Next, the relay array 26 is activated to capably activate certain fertilizer-supplying unit 80 to provide the required parameter to maintain the appropriate environment level throughout the plantation area.

In addition, the device 500 disclosed herein, particularly in the field of profiling and controlling field conditions, in the sensing mechanism, and in the feedback control, is adaptable into any other usages apart from profiling and controlling field conditions associated with growing plants, that may include usages in a lab for practical and examination, in a hospital or medical activities, cooking/baking activities, and etc.

While in the foregoing specification this invention has been described in relation to certain preferred embodiments thereof and many details have been set forth for purpose of illustration, it will be apparent to those skilled in the art that the invention is susceptible to additional embodiments and that certain of the details described herein can be varied considerably without departing from the basic principles of the invention.

1. A device (500) for profiling and controlling a plurality of field conditions in association with plants grown in an environment comprising:
a monitoring component configured to acquire data associated with the field conditions; and
a controlling component configured for regulating the field conditions;
characterized in that the monitoring component comprises at least one integrated sensor systems (10); the controlling component comprises at least one feedback control system (20); and the device (500) further comprises an inference unit configured for receiving and profiling the data from the integrated sensor systems (10); determining revised field conditions in accordance to the plants' requirements based on the data acquired from the integrated sensor system (10), and manipulating the feedback control system (20) in a feedback manner to regulate the field conditions in the environment into the revised state; wherein the inference unit is in communication with the monitoring component and the controlling component.

2. A device (500) as claimed in claim 1 further comprises a plurality of multiple-wire bus (50) configured to connect the integrated sensor system (10), and the feedback control system (20) in a daisy chain manner.

3. A device (500) as claimed in claim 1 further comprises at least one main portal (40) configured for receiving data of the measured field conditions from the integrated sensor system (10) via the multiple-wire bus (50), sending and receiving data in signals to and from the inference unit by means of a wired connection or in signals transmitting by means of a wireless protocol, and sending commands obtained from the inference unit to the feedback control system (20) and the integrated sensor system (10); characterized in that the main portal (40) comprises a power management unit (42), a transceiver (45), a daisy-chain controller (43), a serial interface (47), a microcontroller unit (MCU) (49), a wireless transceiver (48), and a serial memory (41); and the main portal (40) is connected to the integrated sensor system (10) and the feedback control system (20) by means of the multiple-wire bus (50); and the main portal (40) further comprises a main cap (130) in which the daisy chain controller (43) and the transceiver (45) are located.

4. A device (500) as claimed in claim 1 wherein the integrated sensor system (20) comprises a plurality of sensors (60) configured to measure the field conditions in the environment, the sensors (60) are interconnected through a plurality of bus lines; a sensing circuitry configured to generate voltage; a voltage converter (16) configured to convert the voltage to a digital value; a microcontroller unit (15) configured to control the integrated sensor system (10); and the voltage converter (16), and to access the serial memory (41) of the main portal (40); a daisy chain controller (12) configured to select the mode of operation, and to assign the corresponding sensor to access the bus lines in accordance to the commands sent from the inference unit; and a transceiver unit (11) configured to transmit the acquired data of the field conditions to the main portal (40), the transceiver unit (11) is in communication with the main portal 40; characterized in that the modes of operation of the sensors (60) include the sleep, idle and active modes.

5. A device (500) as claimed in claim 4 wherein the sensors (60) each are configured to measure the field condition selected from a group consisting of the phosphate content, the nitrate content, the potassium content, pH, the ambient temperature, humidity, and content of moisture; characterized in that the content of phosphate, nitrate, potassium, and pH are associated with a growing medium used by the plants; and the ambient temperature, humidity, and content of moisture each are measured in the environment.

6. A device (500) as claimed in claim 5 wherein the integrated sensor system (10) is mounted in a sensing unit comprising a bus cap (72) and a sensor tip (76), characterized in that the daisy chain controller (12) and the transceiver (11) of the integrated sensor system (10) are connected to each other and mounted in the bus cap (72); and the microcontroller unit (15), the voltage converter (16), and the sensors (60) are connected in the bus lines and mounted in the sensor tip (76) to monitor the field conditions within the range of sensitivity of the sensors (60) in the environment.

7. A device (500) as claimed in claim 1 wherein the feedback control system (20) comprises a plurality of field condition regulators (30) each configured to regulate the corresponding field condition in the environment; a transceiver (21) configured to receive commands from the inference unit via the main portal 40; a daisy chain controller (22) configured to activate or deactivate the field condition regulator (30); a microcontroller unit (25) configured to receive feedback signal from the inference unit via the main portal (40) and assess the measured field conditions based on predefined values; and relay array 26 configured to activate and operate the field condition regulator selected based on the feedback signal.

8. A device (500) as claimed in claim 7 wherein the plurality of the field condition regulators (30) are selected from a group consisting of a fertilizer supplying unit (80) configured to supply particular required fertilizer to the growing medium of the corresponding plants; a water supplying unit configured to maintain the water content required by the plants; a temperature regulating unit; and a humidity or moisture regulating unit.

9. A device (500) as claimed in claim 8 wherein the fertilizer supplying unit (80) comprises a piping system having a plurality of valves (110) and a plurality of pumps (120); characterized in that the plurality of valves is configured to open and close and to release fertilizer solution when required by means of the pumps (120); and each of the valves (110) is provided with a pump (120).

10. A device (500) as claimed in any one of claims 6 and 9 comprises a plurality of the integrated sensor systems (10) and a plurality of the feedback control systems (20); characterized in that the integrated sensor systems (10) and the feedback control systems (20) are arranged in a plurality of arrays (90) and are connected in each of the arrays (90); and each of the arrays (90) comprises a main portal (40).

11. A method for profiling and controlling a plurality of field conditions in association with plants grown in an environment by means of a field conditions profiling and controller device (500), the method comprises the steps of:
(a) sensing and measuring field conditions by means of at least one integrated sensor system (10), wherein the integrated sensor system (10) comprises a plurality of sensors (60) therein configured to measure the field conditions in the environment;
(b) transmitting data of the measured field conditions to an inference unit;
(c) profiling the data of the measured field conditions, determining revised field conditions in accordance to the plants' requirements based on the data, and sending feedback commands to at least one feedback control system (20), by means of an inference unit; and
(d) regulating the field conditions in the environment into the revised state in accordance to the feedback commands received therefrom, by means of the feedback control system (20), wherein the feedback control system (20) comprises a plurality of field condition regulators (30).

12. A method as claimed in claim 11 further comprising the steps of generating voltage in accordance to the measured field condition by means of a sensing circuitry in the integrated sensor system (10), converting the voltage to a digital value to be fed to the inference unit by means of a voltage converter (50), selecting the mode of operation of the sensors (60) wherein the modes of operation include the sleep, idle, and active modes in accordance to the commands, and assigning at least one of the corresponding sensors (60) to measure the field conditions in accordance to the commands, subsequent to the step (a).

13. A method as claimed in claim 11 further comprises the steps of activating or deactivating the field condition regulators (30) in accordance to the commands subsequent to the step (c).

14. A method as claimed in claim 11 wherein according to the step (a), the field conditions for measurement are selected from a group consisting of the phosphate content, the nitrate content, the potassium content, pH, the ambient temperature, humidity, and the content of moisture; characterized in that the content of phosphate, nitrate, potassium, and pH are associated with a growing medium used by the plants; and the ambient temperature, humidity, and the content of moisture each are measured in the environment.

15. A method as claimed in claim 11 wherein according to the step (d), the plurality of the field condition regulators (30) are selected from a group consisting of a fertilizer supplying unit (80) configured to supply particular required fertilizer to the growing medium of the corresponding plants; a water supplying unit configured to maintain the water content required by the plants; a temperature regulating unit; and a humidity or moisture regulating unit.
